(19) United States
(12) Patent Application Publication
(10) Pub. No.: US 2025/0167506 A1
(43) Pub. Date: May 22, 2025

(54) LASER AMPLIFIER UTILIZING MULTIPLE END PUMP SPOTS AND METHOD OF MANUFACTURE

(71) Applicant: Newport Corporation, Irvine, CA (US)

(72) Inventors: Martin GORJAN, Irvine, CA (US); Matthias KEMNITZER, Irvine, CA (US); Edmund ARRIOLA, Irvine, CA (US)

(73) Assignee: Newport Corporation, Irvine, CA (US)

(21) Appl. No.: 18/841,066

(22) PCT Filed: Feb. 23, 2023
(86) PCT No.: PCT/US2023/013699

§ 371 Date: Aug. 23, 2024

Related U.S. Application Data
(60) Provisional application No. 63/313,605, filed on Feb. 24, 2022.

(51) Int. Cl. H01S 3/094; H01S 3/04; H01S 3/06; H01S 3/083; H01S 3/0941; H01S 3/16; H01S 3/23

(52) U.S. Cl. CPC H01S 3/094053; H01S 3/0407; H01S 3/0606; H01S 3/0617; H01S 3/083; H01S 3/09408; H01S 3/09415; H01S 3/1618; H01S 3/2325

(57) ABSTRACT

The present application discloses various embodiments of a laser amplifier system utilizing multiple end pump spots to pump an optical crystal during the amplification process which includes a telecentric telescope configured to magnify each individual pump beamlet and output the magnified pump beamlets such that the pump beamlets remain parallel and substantially non-divergent incident on an optical crystal positioned within a resonator-like thereby permitting the construction of a compact laser amplifier system.

### CROSS-REFERENCE TO RELATED APPLICATIONS

The present application claims priority to U.S. provisional patent application Ser. No. 63/313,605, filed on Feb. 24, 2022, entitled “Laser Amplifier Utilizing Multiple End Point Spots and Method of Manufacture,” the contents of which is incorporated by reference in its entirety herein.

### BACKGROUND

Presently, current state of the art ultrafast fiber lasers are performance limited. For example, currently available ultrafast fiber lasers are limited with respect to peak power and average power. For example, currently available ultrafast laser devices are typically limited to approximately two hundred watts (200 W) due to, among other things, so-called transversal-mode instabilities. (See C. Jauregui et al, “Transverse mode instability,” Adv. Opt. Photonics 12 (2), 429-484 (2020).

In response, various architectures have been considered for manufacturing ultrafast laser systems having higher peak powers and higher average powers. For example, systems have been proposed which include complex and expensive chirped-pulse amplification (hereinafter CPA) in combination with large-area photonic crystal fibers, possibly permitting pulse energies beyond 1 ml to be achieved. (see F. Roeser et al, “Millijoule pulse energy high repetition rate femtosecond fiber chirped-pulse amplification system,” Opt. Lett. 32, No. 24 (2007). While somewhat useful, this proposed system presented its own limitations and challenges. For example, the inclusion of a CPA increased system complexity and expense.

In response, an Innoslab laser amplifier such as described by Russbueldt (see P. Russbueldt et al, “400 W Yb:YAG Innoslab fs-amplifier”, Opt. Exp. 17, No. 15, (2009), and Russbueldt (see t P. Russbueldt et al, “Optically end-pumped slab amplifier comprising pump modules arranged in a distributed manner,” U.S. Pat. No. 9,484,705B2) addresses and solves both issues, with more than 400 W demonstrated and capable of delivering μl output powers without a CPA and ml output powers with a modest CPA. The Innoslab design uses a homogenized pump field (line) over the entire crystal aperture that is obtained from multiple diode bars. The pump shaping and delivery optics used in the Innoslab system and similar slab amplifiers are complex to design, expensive to manufacture, and are bulky. In addition, signal beam shape and alignment is intricate and time-consuming. Further, achieving very good beam quality (i.e., low beam propagation factor M2 with a round and evenly smooth Gaussian beam through the caustic) is challenging when using the Innoslab system and similar slab amplifiers.

In light of the foregoing, Schulte and Russbueldt authored a proposed solution entitled “Scalable USP Power Amplifier Based on the Multirod Concept” in Fraunhofer Institute for Laser Technology ILT Annual Report 2015. However, the disclosure within the annual report fails to disclose critical technical details, manufacturing considerations, and architectures of the system, instead focusing on the theoretical possibility to constructing such a system. Moreover, the Schulte and Russbueldt paper states that the pump wavelength of 940 nm is preferred, which poses less restrictions on the dichroic mirrors coating design. Additionally, only half (50 W) of the pump power per spots is reported, producing half (150 W) of the maximum power. While useful in some application higher power is needed for some applications.

In light of the foregoing, there is an ongoing need for a high power (>100 W), high repetition rate laser amplifier system.

### SUMMARY

The present application discloses various embodiments of a laser amplifier system utilizing multiple end pump spots to pump an optical crystal during the amplification process. The devices disclosed herein includes a fiber-coupled laser diode array at least one fiber-coupled laser diode array as a pump source. The pump source outputs multiple pump beamlets which are directed into a telecentric telescope configured to magnify each individual pump beamlet and output the magnified pump beamlets such that the pump beamlets remain parallel and substantially non-divergent. The amplifier pump signal, comprised of the multiple magnified pump beamlets, is incident on an optical crystal positioned within a resonator-like amplifier. At least one input signal is also incident on the optical crystal and is amplified by the optical crystal by repeatedly traversing through the resonator-like amplifier and repeatedly being incident up the optical crystal. Finally, the amplified signal is emitted from the resonator-like amplifier. In one embodiment, unlike prior art amplifiers, the present system includes a single telescope to magnify all the pump beamlets while maintaining individual pump beamlets without substantially diverging. In addition, unlike prior art system which required multiple optical crystals, the present systems may include a single optical crystal thereby permitting the construction of a compact laser amplifier system.

In one specific embodiment, the present application is directed to a laser amplifier system and includes at least one fiber-coupled laser diode array configured to output at least one pump signal having a wavelength from 850 nm to 1250 nm. At least one telecentric telescope is in optical communication with the fiber-coupled laser diode array and may be configured to receive the pump signal and output at least one amplifier pump signal. At least one signal source may be configured to output at least one input signal. At least one resonator-like amplifier is in communication with the telecentric telescope and the signal source. The resonator-like amplifier may be defined by at least one signal mirror, at least one pump injection mirror, at least one pump output mirror, and at least one mirror. The resonator-like amplifier may have an optical path length defined by the signal mirror, pump input mirror, and pump output mirror, and the mirror from about 50 mm to about 700 mm. At least one optical crystal position may be within the resonator-like amplifier and may be configured to receive at least a portion of the pump signal and the input signal and output at least one amplifier output signal from the resonator-like amplifier.

In another embodiment, the present application is directed to a laser amplifier system which includes at least one fiber-coupled laser diode array configured to output at least one pump signal formed from multiple pump beamlets individually emitted from the at fiber-coupled laser diode array. A telecentric telescope, in optical communication with the at least one fiber-coupled laser diode array, may be configured to receive the individual pump beamlets forming the pump signal and output multiple magnified pump beamlets forming individual amplifier pump signals. At least one signal source may be configured to output at least one input signal. At least one resonator-like amplifier is in communication with the telecentric telescope and the signal source. The resonator-like amplifier defined by at least one signal mirror, at least one pump injection mirror, at least one pump output mirror, and at least one mirror. An optical crystal may be position within the resonator-like amplifier and may be configured to be pumped by the multiple individual amplifier pump signals and input signal and output at least one amplifier output signal from the resonator-like amplifier.

In yet another embodiment, the present application is directed to a laser amplifier system and includes at least one fiber-coupled laser diode array configured to output at least one pump signal formed from multiple pump beamlets individually emitted from the fiber-coupled laser diode array. A telecentric telescope may be in optical communication with the fiber-coupled laser diode array and may be configured to receive the individual pump beamlets forming the at least one pump signal and output multiple individual amplifier pump signals At least one signal source may be configured to output at least one input signal. At least one resonator-like amplifier may be in communication with the telecentric telescope and the signal source. At least one optical crystal may be position within the resonator-like amplifier and may be configured to be pumped by the individual pump beamlets and the input signal and output at least one amplifier output signal from the resonator-like amplifier.

Other features and advantages of the laser amplifier utilizing multiple end pump spots and methods of manufacture will become apparent from a consideration of the following detailed description.

### BRIEF DESCRIPTION OF THE DRAWINGS

The drawings disclose illustrative embodiments and are not intended to set forth all embodiments of the laser amplifier system utilizing multiple end pump spots and methods of manufacture. Details that may be apparent or unnecessary may be omitted to save space or for more effective illustration. Conversely, some embodiments may be practices without all the detailed disclosed with regard to specific embodiments. When the same reference numbers appear in different drawings, the reference numbers refer to same or similar components or steps. The novel aspects of the laser amplifier system utilizing multiple end pump spots and methods of manufacture as disclosed herein will become more apparent by consideration of the following figures, wherein:

FIG. 1A shows a schematic diagram of an embodiment of a laser amplifier system having a resonator-like amplifier;

FIG. 1B shows a schematic diagram of another embodiment of a laser amplifier system having a resonator-like amplifier;

FIG. 2 shows an elevated perspective view of an embodiment of a laser amplifier system having a resonator-like amplifier;

FIG. 3 shows an exploded elevated perspective view on an embodiment of a fiber-coupled laser diode array pump source for use with an embodiment of a laser amplifier system;

FIG. 4A shows an elevated perspective view on an embodiment of a fiber-coupled laser diode array pump source for use with an embodiment of a laser amplifier system;

FIG. 4B shows an elevated perspective view on another embodiment of a fiber-coupled laser diode array pump source for use with an embodiment of a laser amplifier system;

FIG. 5 shows a side perspective view of an embodiment of a telescope for use with an embodiment of a laser amplifier system;

FIG. 6 shows a side perspective view of an embodiment of a telescope having multiple pump beamlets traversing therethrough for use with an embodiment of a laser amplifier system;

FIG. 7 shows a schematic diagram of an embodiment of a resonator-like amplifier for use with an embodiment of a laser amplifier system;

FIG. 8 shows an elevated perspective view of an embodiment of an optical crystal for use with an embodiment of a laser amplifier system;

FIG. 9 shows an elevated perspective view of an embodiment of an optical crystal having multiple pump beams incident thereon for use with an embodiment of a laser amplifier system;

FIG. 10 shows an elevated perspective view of another embodiment of an optical crystal for use with an embodiment of a laser amplifier system;

FIG. 11 shows an elevated perspective view of another embodiment of an optical crystal for use with an embodiment of a laser amplifier system;

FIG. 12 shows an elevated perspective view of another embodiment of an optical crystal for use with an embodiment of a laser amplifier system;

FIG. 13 shows an elevated perspective view of another embodiment of an optical crystal for use with an embodiment of a laser amplifier system;

FIG. 14 shows an elevated perspective view of another embodiment of an optical crystal for use with an embodiment of a laser amplifier system;

FIG. 15 shows an elevated perspective view of an embodiment of a pump output mirror normal to the optical axis OA for use with an embodiment of a laser amplifier system;

FIG. 16 shows an elevated perspective view of an embodiment of a pump output mirror tilted with respect to the optical axis OA for use with an embodiment of a laser amplifier system;

FIG. 17 shows an elevated perspective view of an amplifier pump signal being introduced into a resonator-like amplifier for use with an embodiment of a laser amplifier system;

FIG. 18 shows an elevated perspective view of an amplifier output signal being emitted from a resonator-like amplifier for use with an embodiment of a laser amplifier system;

FIG. 19 shows a side perspective view of an amplifier signal traversing through an optical crystal in an embodiment of a laser amplifier system;

FIG. 20 shows a side perspective view of an amplifier signal traversing through an optical crystal and a micro-lens array in an embodiment of a laser amplifier system;

FIG. 21 shows a side perspective view of an amplifier signal traversing through an optical crystal and two lenses in an embodiment of a laser amplifier system;

FIG. 22 shows measurements of the beam quality of an amplified signal using an embodiment of a laser amplifier system described herein;

FIG. 23 shows an schematic diagram of an embodiment of a laser amplifier system utilizing multiple emp pump sports in a single pass configuration; and

FIG. 24 shows an schematic diagram of an embodiment of a laser amplifier system utilizing multiple emp pump sports in a multiple pass configuration.

### DETAILED DESCRIPTION

The present application discloses various embodiments of a laser amplifier system utilizing multiple end pump spots for amplification of an optical signal. Exemplary embodiments are described below with reference to the accompanying drawings. Unless otherwise expressly stated, in the drawings the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Many of the embodiments described in the following description share common components, device, and/or elements. Like named components and elements refer to like named elements throughout. For example, the embodiments described in the following detailed description generally include at least one gain media positioned within at least one resonator, amplifier, and/or resonator-like amplifier. In addition, the embodiments described below generally include at least one telecentric telescope to couple at least one resonator pump signal from at least one pump source into the resonator, amplifier, and/or resonator-like amplifier. Those skilled in the art will appreciate that any variety of additional devices or components may be used in the embodiments described below. Further, any variety of alternate telescope systems may be used with the present system. Thus, the same or similar named components or features may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

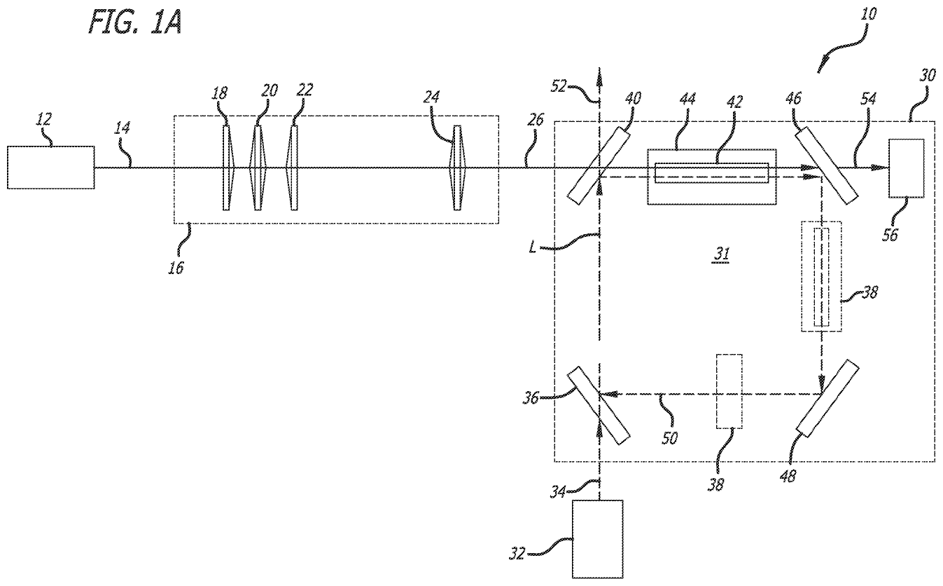

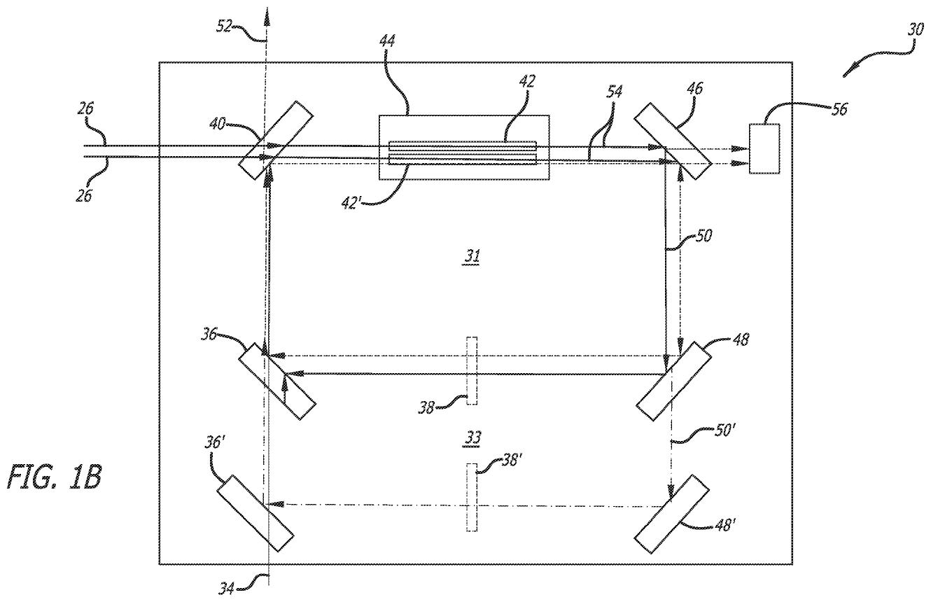

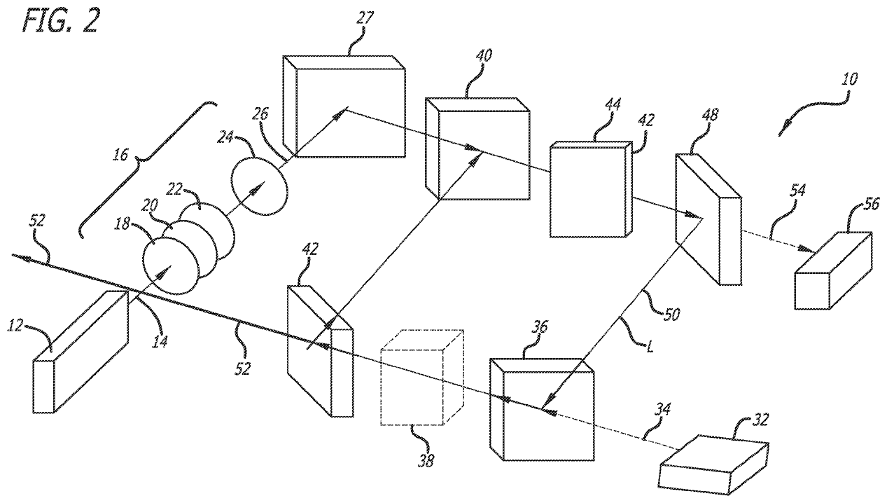

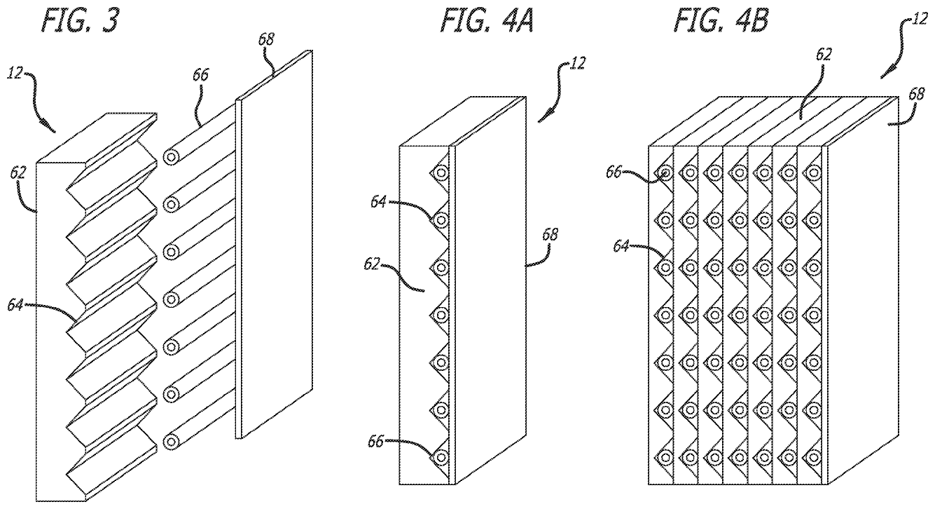

FIGS. 1A, 1B, and 2 show various embodiments of the laser amplifier using multiple end pump spots. While the configurations of the laser amplifier systems shown in FIGS. 1A, 1B, and 2 are different, the systems operate in a similar fashion. As shown in FIGS. 1A and 2, the laser amplifier system 10 includes at least one pump source 12 configured to output one or more pump signals 14. In one embodiment, the pump source 12 comprises one or more fiber-coupled laser diodes or similar emitters (hereinafter fiber array) although those skilled in the art will appreciate that any variety of pump sources may be used with laser amplifier system 10. Optionally, any number of pump signals 14 maybe emitted from any number of pump sources 12. Further, multiple pump beamlets 28a-28g (see FIG. 6) may be used to form the pump signal 14.

Referring again to FIGS. 1 and 2, at least one telescope or optical system 16 may be configured to receive pump signal 14 and output at least one amplifier pump signal 26. In the illustrated embodiment, the telescope 16 includes four (4) lenses or optical devices although those skilled in the art will appreciate any number of lenses or optical devices may be used in the telescope 16. Further, at least one optical device or component within the telescope 16 may be configured to be movable, removable, or otherwise repositionable. In another embodiment, the four lenses 18, 20, 22, and 24 within the telescope 16 may be fixed. For example, the position of the first lens 18, second lens 20, third lens 22 and fourth lens 24 may be fixed while the source 12 is configured to be movable. In the illustrated embodiment, the first lens 18, second lens 20, and third lens 22 comprise individual elements. Optionally, one or more of the first lens 18, second lens 20, the third lens 22 and fourth lens 24 may be coupled to adjoining optics to form a monolithic lens system. In one embodiment, the lenses 18, 20, 22, and 24 are manufactured from fused silica, although those skilled in the art will appreciate that the lenses 18, 20, 22, and 24 may be manufactured from any variety of materials. Optionally, at least one of the lenses 18, 20, 22, and 24 may comprise a spherical lens, or any other lens configuration known in the art. Further, the telescope 16 may include any number of alternate of additional devices, including, without limitations, filters, spatial filters, analyzers, sensors, mirrors, gratings, and the like.

As shown in FIGS. 1A and 2, the amplifier pump signal 26 from the telescope 16 is directed into at least one amplifier 30. In FIG. 2 at least one mirror or similar device 27 may be used to direct the amplifier pump signal 26 into the resonator, amplifier, and/or resonator-like amplifier. In the illustrated embodiments shown in FIGS. 1A, 1B, and 2, the amplifier 30 comprises a ring resonator-like amplifier although those skilled in the art will appreciate any variety, type, and/or configuration of resonator-like amplifiers may be used in the laser amplifier system 10. As such, the amplifier 30 will be referred to as a resonator-like amplifier (hereinafter RL amplifier 30). In the illustrated embodiments, the RL amplifier 30 includes at least one pump input mirror 40 in optical communication with the telescope 16. The pump input mirror 40 may be configured to permit at least a portion of the amplifier pump signal 26 to propagate therethrough. Thereafter, the amplifier pump signal 26 may be incident upon one or more optical crystals or gain media 42 position within the RL amplifier 30. In the illustrated embodiment, the gain media 42 is positioned on at least one optical mount or stage 44. In one embodiment, the position of the optical mount 44 within the RL amplifier 30 may be fixed. Optionally, the optical mount 44 may be movably positioned within the RL amplifier 30. During use, the amplifier pump signal 26 may be configured to deliver pump energy to the gain media 42.

Referring again to FIGS. 1A, 1B, and 2, the amplifier pump signal 26 traverses through the gain media 42 and is incident on at least one mirror positioned within the RL amplifier 30. In the illustrated embodiment, the amplifier pump signal 26 traverses through the pump output mirror 46 to form an expended pump signal 54. Optionally, a portion of the pump signal 26 may be reflected by the pump output mirror 46. Thereafter, the expended pump signal 54 may be directed into one or more beam dumps or similar devices 56.

In addition, one or more optical signals to be amplified (hereinafter input signal 34) may be directed into the RL amplifier 30. In the illustrated embodiments, at least one signal source 32 emits at least one input signal 34 which is directed into the RL amplifier 30. Any variety of devices may be used as a signal source 32, including without limitations, mode-locked femtosecond laser sources, laser sources having one or more preamplifiers, broadband optical sources, picosecond optical sources, nanosecond optical sources, CW optical source, and the like. Optionally, the signal source 32 comprises the output signal of a similar laser amplifier system 10, thereby forming a multi-stage amplifier. More succinctly stated, the amplified output signal 52 of the RL amplifier 30 shown in FIGS. 1A, 1B, and 2 may serve as the input signal 34 of another or subsequent RL amplifier (not shown) or other amplifiers known in the art. In the illustrated embodiment, the input signal 34 may be configured to be injected into the RL amplifier 30 directly, thereby forgoing or interacting with the signal mirror 36 or 36′ if present (See FIG. 1B). As such, in one embodiment, the signal mirror 36 (and/or 36′) may be configured to permit at least a portion of the input signal 34 to traverse therethrough, thereby permitting the input signal 34 to be injected into the resonator-like amplifier 10. In another embodiment, the input signal 34 may be injected in the resonator-like amplifier 10 without engaging the input mirror 36, (and/or 36′). For example, the input signal 34 may be configured to traverse below, above, or aside the signal mirror 36, (and/or 36′). At least one of the mirrors 36, 40, 46, and 48 as well as 36′ and 48′, if present, may include one or more coatings configured to be highly reflective at the wavelength of the input signal 34 . . . . In addition, at least one of the mirrors 36, 40, 46, 48 (and 48′ if present) may comprise a dichroic mirror configured to be highly reflective to the wavelength of the input signal 34/amplified signal 50, while being highly transmissive to the wavelength of the amplifier pump signal 26, thereby permitting the amplifier pump signal 26 to be extracted from the RL amplifier 30. For example, the pump input mirror 40 and pump output mirror 46 may both include one or more dichroic coating applied thereto, the dichroic coatings configured to be highly reflective at the wavelength of the amplified signal 50 while being highly transmissive at the wavelength of the amplifier pump signal 26. As a result, pump light may be easily removed from the resonator 40 after providing pump energy to the gain media 42. In addition, at least one of the mirrors 36, 40, 46, and 48 and mirrors 36′ and 48′ (if present) may include a planar and/or wedged body. The input signal 34 may be reflected by the pump input mirror 40 and directed to the gain media 42. The gain media 42 may be selected to amplify the input signal 34. As such, the signal source 32 may be selected to provide an input signal 34 having a wavelength configured to permit amplification of the input signal 34 based on the material used construct the gain media 42. In one embodiment, the pump output mirror 46 may be positioned having a slight wedge, tilt, or cant (e.g. ^{˜}few deg.) thereby permitting varying the astigmatism of the pump signal within the optical crystal 42 due to pump beam convergence through 46 which is nominally plan parallel plate at large angle (e.g. ^{˜}45°). Resulting unwanted shifting of the pump beam axis of propagation after the pump output mirror 46 may be compensated with adjustment of the axis of the amplifier output signal 52.

Thereafter, referring again to FIGS. 1A, 1B, and 2, at least one amplified signal 50 emitted by the gain media 42 may be reflected by one or more additional mirrors position within the RL amplifier 30. For example, in the illustrated embodiments, the RL amplifier 30 includes at least one pump output mirror 46 configured to reflect substantially all of the amplified signal 50 while transmitting the amplifier pump signal 54 from the RL amplifier 30 to at least one beam dump 56. The pump output mirror 46 may include one or more dichroic coatings configured to reflect substantially all the amplified signal 50 into the RL amplifier 30 while transmitting essentially all the amplifier pump signal 54 therethrough. In the illustrated embodiment shown, at least one amplifier mirror 48 is positioned within the RL amplifier 30 to direct the amplified signal 50 to the input signal mirror 36 thereby forming a ring RL amplifier 30. For example, as shown in FIG. 1A, a single amplification pathway 31 may be created within the RL amplifier 30.

In contrast, FIG. 1B shows an embodiment of a RL amplifier 30 having a first amplification pathway 31 and at least a second amplification pathway 33 formed therein. In one embodiment, a single optical crystal 42 may be used to provide the amplified signal 50 to the a first amplification pathway 31 and at least a second amplification pathway 33. In the embodiment shown in FIG. 1B, a first optical crystal 42 is configured to provide an amplified signal 50 to the a first amplification pathway 31 while at least a second optical crystal 42′ may be configured to provide at least an amplified signal 50 to the second amplification pathway 33. In one embodiment, the first and second optical crystals 42, 42′ are manufactured from the same material. Optionally, the first and second optical crystals 42, 42′ are manufactured from different materials. Further, one or more additional optical elements or components 38, 38′ may be positioned within the RL amplifier 30. Exemplary additional components 38 include, without limitations, lens systems, micro lens arrays, filters, spatial filters, mechanical blockers in the form of one or more holes or lines (comb), transmissive optical elements, gain media, optical crystals, polarizers, wave plates, and the like. Those skilled in the art will appreciate that the RL amplifier 30 may be configured to have any desired optical path length L defined by the total distances between the mirrors 36, 40, 46, and 48. For example, with regard to FIGS. 1A and 2, the optical path length L may be from about 50 mm to 400 mm. In another embodiment, the optical path length L may be from about 80 mm to 120 mm. Optionally, the optical path length L may be from about 100 mm to 110 mm. In contrast, the optical path length L (i.e. the total distance between 36′, 36, 40, 46, 48, and 48′ of the RL amplifier shown in FIG. 1B may be from about 80 mm to 700 mm. In an specific embodiment, the optical pathlength L is from about 100 mm to about 140 mm.

FIGS. 3, 4A, and 4B show various views of an exemplary pump source 12 for use with the laser amplifier system shown in FIGS. 1 and 2. However, those skilled in the art will appreciate while the present application discusses using one or more fiber coupled-diode lasers as a source of one or more pump signals 14 any number and variety of laser systems may be used provide energy to the gain media 42 positioned within the RL amplifier 30 (see FIGS. 1 and 2). In one embodiment, the pump source 12 includes one or more fiber-coupled mid-power laser diodes. More specifically, each fiber-couple laser diode may be configured to output at least one pump signal having a pump power between 1 W and 1500 W. In a more specific embodiment, each fiber-coupled laser diode may be configured to output at least one pump signal having a pump power of about 50 W to 200 W. Optionally, each fiber-coupled laser diode may be configured to output at least one pump signal having a pump power of about 100 W or more, although smaller laser amplifiers may be constructed using fiber-coupled laser diodes configured to output at least one pump signal having a pump power of about 10 W or more. Optionally, very low power amplifier system may be constructed using by using a similar architecture to the architecture described in the present application and utilizing very low power pump sources, For example, pump sources 12 capable of outputting a pump signal 14 on the order of a 1 mW or less.

Referring again to FIGS. 3, 4A, and 4B, the pump source 12 may be configured to output at least one pump signal 14 at any desired wavelength, which is largely dependent on the material used to construct the gain media 42. In one embodiment, the pump signal 14 has a wavelength of about c, although those skilled in the art will appreciate that any variety of wavelength may be used. In another embodiment, the pump signal 14 has a wavelength of about 940 nm to about 1000 nm. Optionally, the pump source 12 is configured to output at least one pump signal 14 having a wavelength of about 960 nm to about 990 nm. In one specific embodiment, the pump signal 14 has a wavelength from about 969 nm to about 971 nm. In another specific embodiment, the pump signal 14 has a wavelength from about 970 nm to about 980 nm. As shown, the pump source 12 includes a pump source body 62 defining one or more v-grooves or similar fiber alignment aides 64 formed therein or positioned thereon, thereby permitting the fiber optic bodies 66 of the fiber-coupled laser diodes to be precisely and securely positioned therein. In one embodiment fiber diameter is between 20 μm and 200 μm, and numerical aperture (NA) between 0.05 and 0.22. In another embodiment fiber diameter is between 50 μm and 110 μm and NA between 0.1 and 0.22. In another specific embodiment fiber diameter is between 90 μm and 110 μm and NA between 0.1 and 0.22. Further, at least one cover plate 68 may be used to secure the one or fibers within the pump source body 62. In the illustrated embodiment, seven (7) fibers 66 each coupled to at least one laser diodes are positioned within the v-grooves 64 formed in the pump device body 62 thereby forming at least one v-groove array. Those skilled in the art will appreciate that any number of fibers 66 may be used to form the pump source 12. For example, two (2) fibers 66 may be used. In another embodiment, ten (10) fibers 66 are used. During use, each fiber 66 is configured to output a pump beamlet which, when combined with the pump beamlets emitted by other fibers 66 within the pump source 12 cooperatively form the pump signal 14. As such, the pump signal 14 is comprised of numerous pump beamlets each emitted by an individual fiber 66.

In one embodiment, the v-grooves 64 formed in the device body 62 are substantially parallel. Optionally, the v-grooves 64 formed in the device body 62 are substantially non-parallel. For example, fibers 66 they have a fiber pitch from about 5 μm or less to about 2500 μm or more. In another embodiment, fibers 66 may have a fiber pitch from about 250 μm to about 700 μm. In yet another embodiment, fibers 66 have a fiber pitch of about 500 μm. Those skilled in the art will appreciate that any number of fibers 66 may be positioned within the pump device body 62. In one embodiment, at least one of the fibers 66 comprises a single mode fiber. In another embodiment, at least one of the fibers 66 comprises multimode fiber. In another embodiment, at least one of the fibers 66 comprises multimode fiber with diameter or NA other than the rest of the fibers. In one embodiment, at least one of the pump device body 62 and cover plate 68 is manufactured from glass. Optionally, at least one of the pump device body 62 and cover plate 68 may be manufactured in a variety of materials including, without limitations, composite materials, alloys, ceramic materials, metals, elastomers, polymers, crystals, crystalline materials, and the like. Alternatively, other means of manufacture of the fiber array may include but not limited to mounting (e.g. adhesively bonding) fibers individually in precision drilled holes or fusing fibers to a glass plate or similar substrate. In addition, the embodiments of the laser amplifier system 10 shown in FIGS. 1 and 2 utilizes a single pump source 12. Optionally, any number of pump sources 12 may be used with the laser amplifier system and shown in FIGS. 1 and 2. The illustrated embodiment, the fibers 66 positioned vertically within the pump device body 62. Optionally, at least one of the fibers 66 may be positioned horizontally within the pump device body 62. In another embodiment, fibers 66 may be positioned both vertically and horizontally within the pump device body 62. FIG. 4A shows an embodiment of the pump source 12 having numerous fiber emitters vertically aligned along a common vertical axis. In contrast, FIG. 48 shows an embodiment of a pump source having fiber emitters distributed in a vertical and horizontal distribution within the pump source body 62.

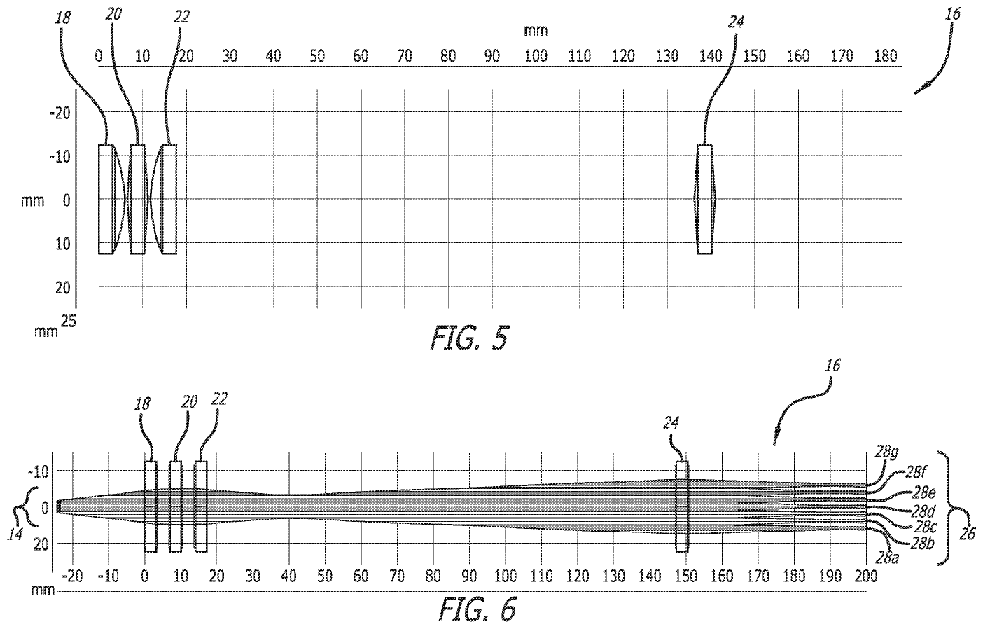

FIGS. 5 and 6 show various views of an embodiment of a telescope or optics system 16 for use with the laser amplifier system 10 shown in FIGS. 1 and 2. In one embodiment, the telescope 16 includes multiple lenses. More specifically, in one embodiment telescope 16 includes a first lens 18, a second lens 20, a third lens 22, and a fourth lens 24. Optionally, any number of lenses, stops, apertures, irises, and/or optical devices may be used form the telescope 16. Further, any type telescope may be the first lens 18, the second lens 20, the third lens 22, and the fourth lens 24. In one embodiment, the telescope 16 comprises a telecentric telescope. As such, in one embodiment the first lens 18, second lens 20, and third lens 22 form a triplet while the fourth lens 24 forms of lens singlet. Further, the lenses 18, 20, 22, 24 may be fixed while the pump source body 62 may be movable. Optionally, at least one of the lenses used in the telescope 16 may be configured to be movable. As such, the telescope 16 may be configured to provide target spot size ranging from about 10 μm or less to about 2000 μm or more. In another embodiment, the telescope 16 may be configured to provide target spot size ranging from about 200 μm to about 800 μm. Optionally, the telescope 16 may be configured to provide target spot size ranging from about 380 μm to about 475 μm. The telescope 16 may be configured to have any desired magnification. In one embodiment, the telescope 16 has a magnification of about four times (4×). In another embodiment, the telescope 16 has a magnification of about two times (2×). Optionally, the telescope 16 may be configured to have a magnification of about 10 times (10×) or more.

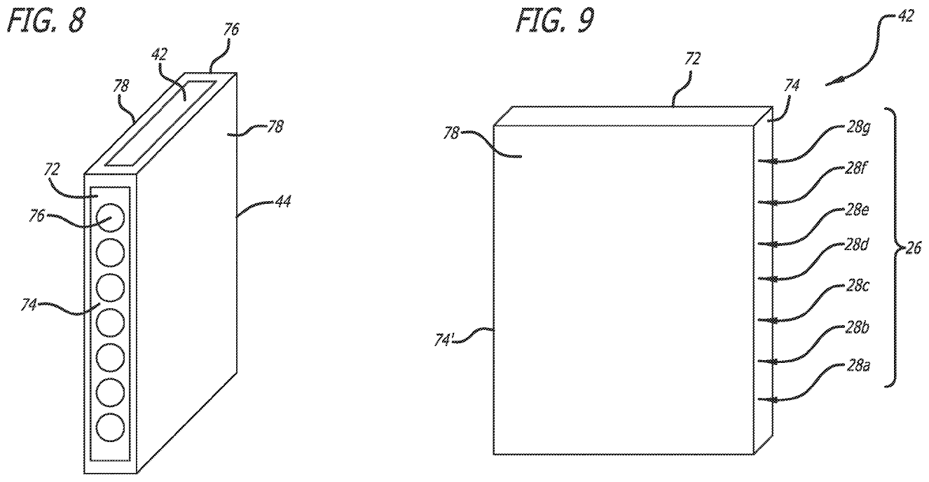

As shown in FIG. 6, the telescope 16 receives the pump signal 14, which is comprised of pump beamlets emitted by the individual fiber-coupled laser diodes used in the pump source 12 and magnifies the pump signal 14 to output at least one amplifier pump signal 26. As shown, the amplifier pump signal 26 is comprised of the magnified beamlets 28a-28g forming the pump signal 14. Those skilled in the art will appreciate that the number of pump beamlets forming the pump signal 14 corresponds to the number of laser diodes or other pump energy emitters used form the pump source 12. Optionally, the multiple beamlets 28a-28g are incident upon the optical crustal 42 such that substantially all the facet 74 (See FIG. 8) of the optical crystal 42 is being pumped by the amplifier input signal 26. In another embodiment, the amplifier input signal 26 is incident on only a portion of the facet 74. Those skilled in the art will appreciate that the amplifier pump signal 26 may have any desired polarization. In one embodiment, the amplifier pump signal 26 has s-polarization pump signal. In another embodiment, the amplifier pump signal 26 has p-polarization. Optionally, the amplifier pump signal 26 need not be polarized.

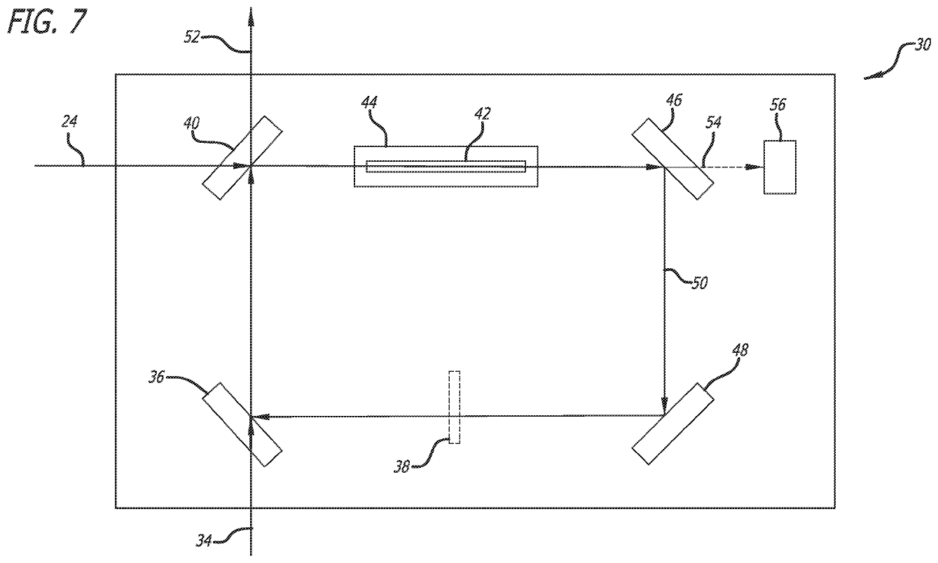

FIGS. 7-16 show various elements used to construct the RL amplifier 30 used in the laser amplifier system 10. As shown in FIG. 7, the RL amplifier 30 includes multiple mirrors therein. In one embodiment, the RL amplifier 30 includes four mirrors 40, 46, 48, and 36. As shown, the RL amplifier 30 may form a ring resonator-like amplifier. Optionally, the laser system 10 may be configured to use any resonator-like amplifier configuration. The RL amplifier 30 includes at least one gain media or optical crystal 42 therein. The gain media 42 may be positioned within or retained by at least one optical mount 44. In one embodiment, the optical mount 44 is positioned within a fixed location within the RL amplifier 30. Optionally, the optical mount 44 may be positioned within the RL amplifier 30. As such the optical mount 44 may be selectively movable. Further, the optical mount 44 may be configured to provide one or more cooling fluids or thermal control fluids to the gain media 44, thereby permitting the user to thermally manage environmental conditions within the resonator 34 or the gain media 42. Optionally, the optical mount 44 need not include thermal management systems or devices.

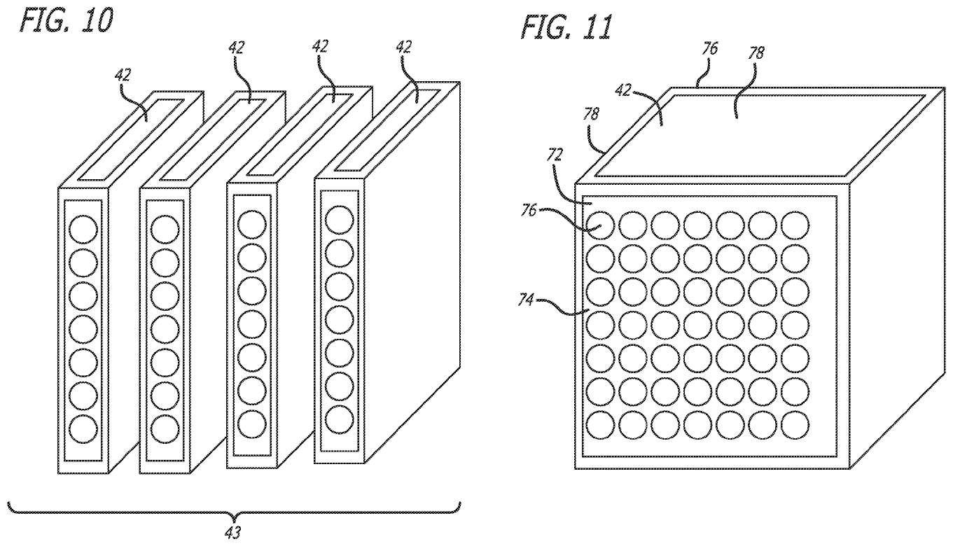

As shown in FIGS. 8 and 9, the gain media 42 includes at least one device body 72 having at least one end facet 74 and at least one elongated facet 78. As shown in FIGS. 8 and 9, in one embodiment the gain media 42 is configured to receive the amplifier pump signal 26 on the end facet 74. In another embodiment, the gain media 42 is configured to receive the amplifier pump signal 26 on the elongated facet 74. As shown, seven pump spots 76 are formed on the end facet 74 of the gain media 42, which correspond to the pump beamlets 28a-28g forming the amplifier pump signal 26. Any number of pump spots 76 could be formed on the end facet 72 of the gain media 42. As shown in FIG. 9, during use the amplified signal 50 traversing through the resonator-like amplifier 30 is incident on optical crystal 42 at a different pump spot 74 than the previous Further, although the pump spots are vertically arranged those skilled in the art will appreciate that any number of pump spots in any variety of orientations may be formed on the end facet 74 of the gain media 42. Optionally, multiple gain media 42 may be positioned within the RL amplifier 30. For example, as shown in FIG. 10, four (4) gain media 42 are positioned adjacent to each other to provide a gain media system 43 offering a compact, large gain amplifier system. In one embodiment, one or more thermal management devices or systems (not shown) may be positioned between each gain media 42 to selectively control the thermal characteristics of the gain media system 43. Optionally, the gain media system 43 need not include a thermal management system. For example, FIG. 11 shows a monolithic gain media 42 allowing for vertically and horizontally distributed end spot access to increase amplifier gain.

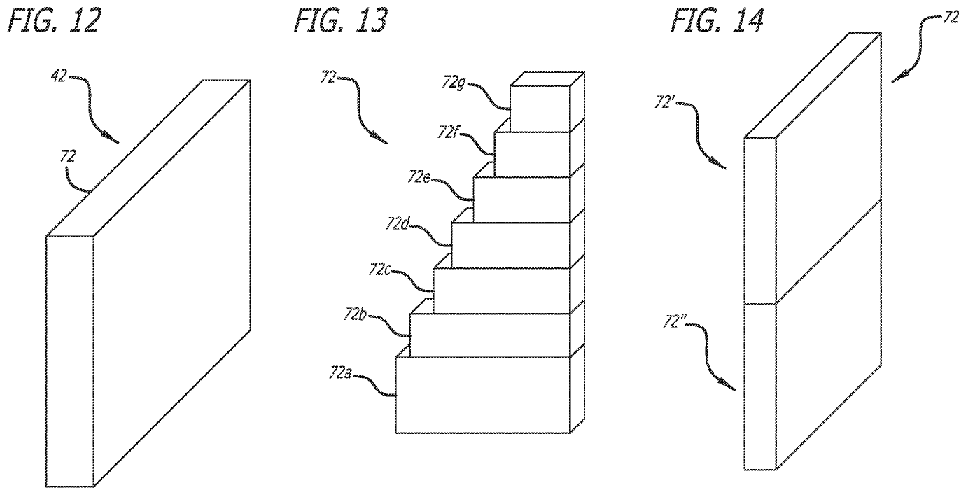

As shown in FIGS. 8-14, gain media 42 may be manufactured in any variety of configurations, materials, doping levels, and the like. For example, in one embodiment gain media 42 is manufactured from Yb:YAG material grown as single crystal. In another embodiment gain media 42 is manufactured from Yb:YAG material as ceramics. In another embodiment, gain media 42 is manufactured from Yb:Lu2O3, Yb:Sc2O3, Yb:GGG, Yb:KYW, Yb:CALGO, Yb:CaF₂, Yb:CNGG, various laser ceramics, and the like. In one embodiment, the gain media 42 is manufactured from a single Yb-doped material having a consistent and/or uniform doping concentration within the crystal body. In contrast, FIG. 9 shows an embodiment of the gain media 42 having varied and/or non-uniform doping concentration within the crystal body. More specifically, the gain media body 72 at a lower concentration of doping in the end facet 74 as compared to the opposing end facet 74′. As such, doping concentration within the gain device body 72 is variable along the horizontal plane. As a result, the pump beamlets 28a-28g of the pump signal 26 are incident on the lower doped end facet 74 of the gain media body 72. More succinctly stated, the pump beamlets 28a-28g encounter greater doping concentrations while traversing through the gain media body 72. In contrast, FIG. 12 shows an embodiment of the gain media body having doping concentrations varying along the vertical plane. In another embodiment, FIG. 13 shows an embodiment of the gain media body 72 constructed from multiple gain media body segments 72a-72g having different transverse dimensions, thicknesses, lengths, heights, widths, doping concentrations, gain media materials, and/or the like. Yet another embodiment, FIG. 14 shows a gain media body 72 formed from a first gain media body material 72′ and at least a second gain media body material 72″.

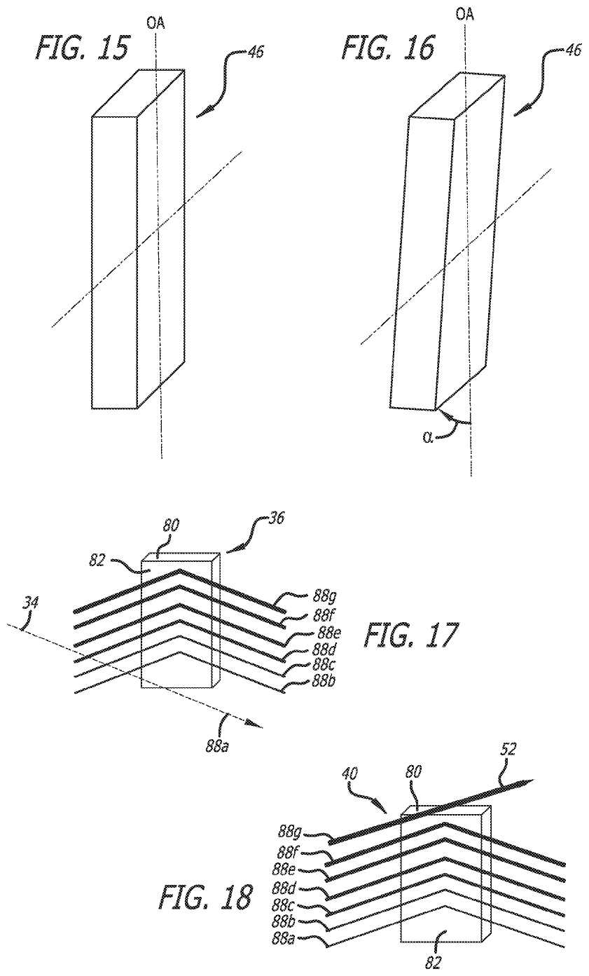

As shown in FIG. 7, the mirrors 36, 40, 46, and 48 may be used to form the RL amplifier 30. As shown in FIG. 15, in one embodiment, at least one of the mirrors 36, 40, 46, 48 may be positioned normal to the optical axis OA. In another embodiment, as shown in FIG. 16, at least one of the mirrors 36, 40, 46, 48 may be tilted or deviated from the optical axis OA. In one embodiment, the input signal mirror 36 and the pump output mirror 46 are tilted at some angle α from the normal optical axis (e.g. 2 degrees or more), thereby permitting the input signal 34 to be incident on the optical crystal 42 at a different location than the previous spot on the optical crystal 42 as the input signal 34 continues to repeatedly traverse through the resonator-like amplifier 30. Those skilled in the art will appreciate that at least one of the mirrors 36, 40, 46, and 48 may be tilted any desired degrees. Optionally, at least one of the mirrors 36, 40, 46, 48 may include a wedged body thereby permitting the input signal 34 to be incident on the optical crystal 42 at a different location than the previous spot on the optical crystal 42 as the input signal 34 continues to repeatedly traverse through the resonator-like amplifier 30. As a result, the amplified signal 50 will be incident on a different portion of each mirror 36, 40, 46, and 48 as the amplified signal 50 repeatedly is amplified by the gain media 42 and traverses through the RL amplifier 30. Optionally, one or more optional optical elements 38 may be used within the RL amplifier 30 to change the position of the amplified signal 50 within the RL amplifier 30 (see FIGS. 1 and 2). For example, in one embodiment, one or more Brewster plates or devices may be used to change the position of the amplified signal 50 each time the amplified signal 50 traverses through the RL amplifier 30. Those skilled in the art will appreciate any variety of optical devices or components may be used to change the position of the amplified signal 50 as the amplified signal 50 traverses through the RL amplifier 30. In the illustrated embodiment, the RL amplifier is analogous to an open ring resonator or a “quasi”-resonator. Optionally, at least one of the mirrors 36, 40, 46, 48 may comprise an end mirror thereby closing the open ring resonator-like features and providing a resonator having very low intracavity power but high output power.

FIGS. 7, 17, and 18 show embodiments of an input signal mirror 36 and pump input mirror 40 having a resonator signal 88a-88g repeatedly incident thereon. More specifically, FIG. 17 shows the input signal 34 being introduced into the RL amplifier 30 and amplifier signal 88a-88g being reflected by the input signal mirror 36. In contrast, FIG. 18 shows the amplifier pump signal 26 being emitted into the RL amplifier 30 and the amplifier signal 88a-88g being directed to the gain media 42 by the pump input mirror 40. Those skilled in the art will appreciate that the amplifier signal 88a-88g represents the sequential passes of the amplified signal 50 through the RL amplifier 30 and are only illustrated as such to show the resonator signal 88a-88g repeatedly changing position of traversing through the RL amplifier 30. In the embodiment shown in FIG. 17 the input signal 34 (or multiple input signals 34 is present) may be directed into the RL amplifier 30 without traversing through the input signal mirror 36. For example, as shown in FIG. 17 the input signal 34 may be injected into the RL amplifier 30 below the input signal mirror 36, thereby forming at least one amplifier signal 88a. Optionally, the input signal 34 may be injected into the RL amplifier 30 above the input signal mirror 36. In another embodiment, the input signal 34 may be injected into the RL amplifier 30 beside the input signal mirror 36. Those skilled in the art will appreciate that any of the mirrors 36, 40, 46, 48 may operate as a pump input mirror and/or input signal mirror, thereby allowing for the present system to be adapted for any number, type, and configuration of master oscillator power amplifier architectures.

Thereafter, as shown in FIG. 18, the amplifier signal 88a, which represents the input signal 34 within the RL amplifier 30, may be incident on and reflected by the pump input mirror 40 which directs the amplifier signal 88a to the gain media 42. As stated above, the input signal 34 may comprise the amplified output signal of another laser amplifier system 10 thereby forming a multi-stage laser amplifier. The amplified resonator signal 88b emitted from the gain media 42 may be directed by the pump output mirror 46 and the amplifier mirror 40 back to the input signal mirror 36. As shown, in one embodiment the amplifier signal 88b is displaced from the resonator signal 88a. Each time the amplifier signal 88a-88f traverses through the RL amplifier 30 and is amplified by the gain media 42 (which is shown by the increased thickness of the amplifier signals 88a-88g in FIGS. 17 and 18) the amplifier signal 88b-88g is displaced from the preceding amplifier signal 88a-88g. Finally, as shown in FIG. 18, the amplifier signal 88g may be configured to avoid the pump input mirror 40 thereby permitting the amplifier signal 88g to be emitted from the RL amplifier 30 form at least one amplified output signal 52. In the illustrated embodiment the amplifier signal 88a-88g is configured to complete seven (7) passes through the RL amplifier 30. Those skilled in the art will appreciate that the RL amplifier 30 may be configured to have the amplifier signal 88a-88g complete any number of passes through the RL amplifier 30 thereby permitting the user to control or modify the amplification of the amplifier signal 88a-88g. As described above, at least one of the mirrors 36, 40, 46, 48 may be tilted to enable sequential displacement of the resonator signal 88a-88g in the RL amplifier 30. For example, the input signal mirror 36 and the pump output mirror 46 may be tilted to cooperatively reposition and displace the resonator signal 88a-88g each pass RL amplifier 30. In the alternative, one or more Brewster plates or similar position shifting devices may be used to change the position of the amplifier signal 88a-88g each time the amplifier signal 88a-88g traverses through the RL amplifier 30.

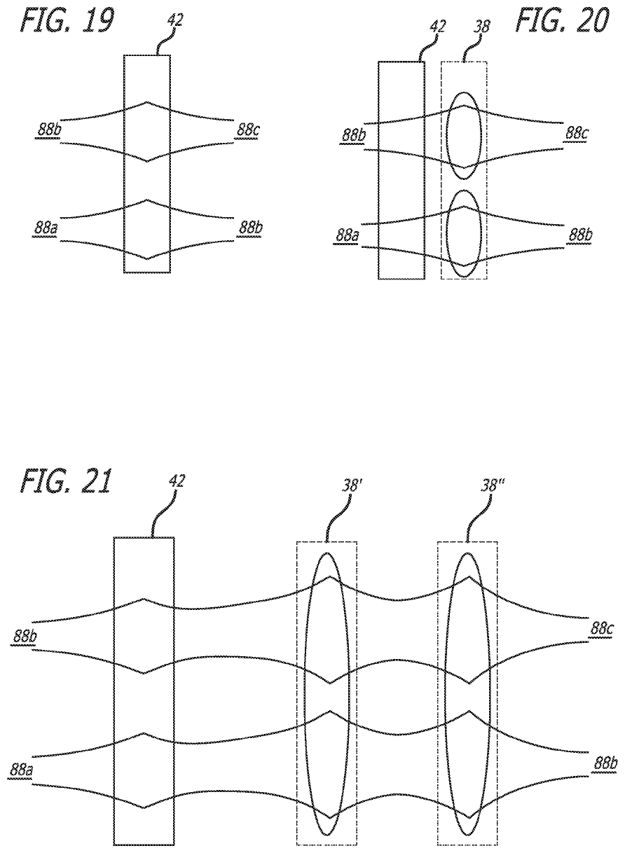

FIGS. 7 and 19-21 shows various view of the gain media 42 within the RL amplifier 30 amplifying the incident signal. As shown in FIGS. 19-21, the amplifier signal 88a traverse through the RL amplifier 30 and is directed by the pump input mirror 40 to the gain media 42. The input signal 88a is amplified within the gain media 42 which outputs the amplifier signal 88b. The amplifier signal 88b is slightly repositioned within the RL amplifier by, for example at least one tilted mirror 36, 40, 46, 48 within the RL amplifier 30 and is directed by the mirrors 46, 48, 36, 40 back to the gain media 42. As such, the location of the amplifier signal 88b incident on the gain media 42 is displaced relative to the location where the amplifier signal 88a was incident on the gain media 88a. Further, amplifier signal 88b in amplified by the gain media to produce the amplified signal 88c emitted from the gain media 42. This process is repeated any number of times as the amplified signal 50 (see FIG. 7) repeatedly traverses through the RL amplifier 30 until ultimately be emitted from the RL amplifier 30. Optionally, as shown in FIG. 20, at least one micro-lens array or similar optical component 38 may be used to focus, image, or otherwise modify the amplified signals 50 within the RL amplifier 30 (see FIG. 7). In another embodiment, one or more large area lenses or similar components could also be positioned within the RL amplifier 30.

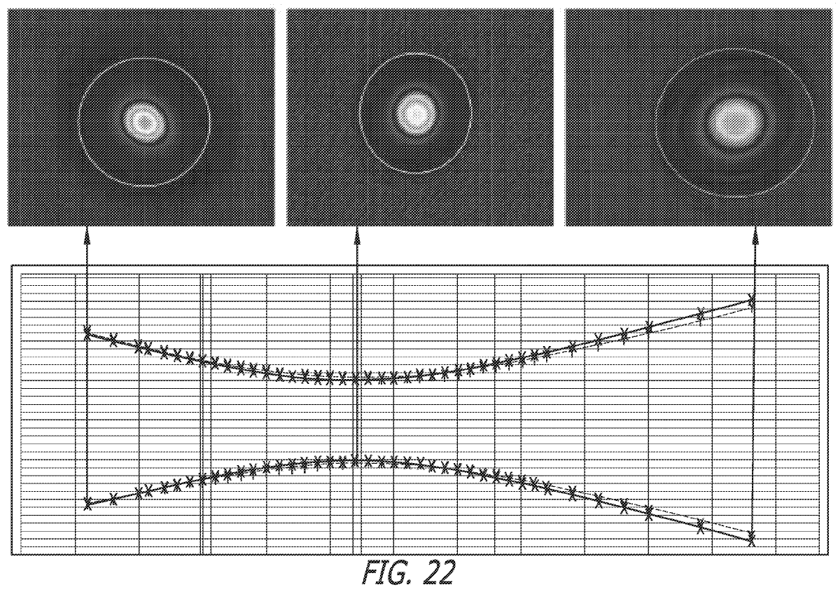

The amplifier signal 88a-88g may have any desired polarization. For example, in one embodiment at least one of the amplifier signals 88a-88g is vertically polarized (s polarization). In another embodiment, at least one of the amplifier signals 88a-88g is horizontally polarized (p polarized). Optionally, at least one of the amplifier signals 88a-88g may be partially polarized non-polarized. In the illustrated embodiment, the amplifier signal 88a-88g is directed above the pump input mirror 40 the form at least one amplified output signal 52. Optionally, the amplifier signal 88a-88g may be directed below or beside the pump input mirror 40 the form at least one amplified output signal 52. In one embodiment, the amplified output signal 52 has a wavelength of about 1020 nm to about 1040 nm, although those skilled in your will appreciate that the wavelength of the amplified output signal 52 dependent on the gain media material. Further, in one embodiment the amplified output signal 52 has a power from about 10 W to about 300 W or more. Those skilled in the art will appreciate that the output power from the RL amplifier 30 is dependent on a number of factors, including, without limitations, the gain media 42 used, the pump wavelength, the pump power, thermal management of the gain media 42, number of passes through the gain media 42 and the like. In one specific embodiment the amplified output signal 52 has a power from about 150 W to about 300 W. FIG. 22 shows various measurements of the amplified output signal 52. A laser amplifier system as described in FIG. 1 was constructed. Each fiber-coupled laser diode provided about a 100 W pump beamlet 28a-28g (see FIG. 6) to form an amplifier signal 26 which was directed to the gain media 42. Optionally, fiber-coupled laser diode provided about a 300 W pump beamlet 28a-28g (see FIG. 6) to form an amplifier signal 26 which was directed to the gain media 42. Those skilled in the art will appreciate that the fiber-coupled laser diode may be configured to provided about a pump beamlet 28a-28g (see FIG. 6) having a pump power from about 2 W to about 1500 W or more. In addition, an input signal 34 having a power of about 2 W was injected into the RL amplifier 30. In one embodiment, the input signal 34 has an input power of about 100 W. Optionally, the input signal 34 may have an input power of about 70 W to about 140 W. Optionally, the input signal 34 may have an input power of about 40 W to about 300 W. In short, the input signal 34 may have any desired input power. The amplified output signal 52 has a power of about 280 W while having excellent beam quality as measured quantitatively by the beam propagating factor (M²X<1.1, M²Y<1.1), and additionally qualitatively by the smooth round beam shape with minimal deviations from the perfect Gaussian beam (TEM00). Again, those skilled in the art will appreciate that the pump power, input power, spectral in-band power, output power, and beam quality may be varied as desired.

The laser amplifier system shown in FIGS. 1 and 2 enables amplification of few Watt input signal to high output powers (>300 W) and high energies (m) class, low non-linearity) with excellent, almost diffraction-limited beam quality. In one embodiment, this is achieved without additional need for beam shaping (astigmatism correction) or spatial filtering (cleaning of higher order modes, with losses) within the resonator 10. As such, the inclusion of additional transmissive optics, beam shaping components, and similar devices is not required thereby providing a closely-packed and easily scalable design with minimal non-linearity. Rather than rely on additional optics components within the RL amplifier 30 the laser amplifier system 10 a stable ring laser resonator formed with a thermal lens which is formed in the gain media with sufficient energy and a sufficient end pump spot size, thereby allowing for larger large spot sizes that reduce B-Integral to a minimum, and the spot size in the gain media 42 will not get smaller than optimum.

In one embodiment the RL amplifier 30 has a round-trip distance of about 100 mm thereby forming at least one thermal lens on the spot formed on the gain media 42. In one embodiment, the formed thermal lens has focal length between 30 mm and 100 mm. In one specific embodiment, the formed thermal lens has focal length of about 50 mm, thus forming a stable ring resonator mode with the waist size of about 250 μm diameter outside of the gain media 42. The mode size inside the gain media 42 is thus about 380 μm. Optionally, amplifier pump signal 26 maybe the RL amplifier 30 so as to match the ring cavity mode (i.e. with a waist size diameter of about 430 μm in a position inside the gain media 42). Optionally, resonator input signal 34 may be coupled into the RL amplifier 30 so as to match the ring cavity mode (i.e. with a waist size diameter of about 250 μm in a position of about 50 mm before the gain media 42. As a result, laser system 10 may be constructed to provide self-sustaining design both with respect to longitudinal variations (e.g. varying thermal lens power) and transversal variations (e.g. slight misalignment of one or more mirrors 36, 40, 46, 48) or input beam 34. As a result, an increase in the thermal lens effects may be easily compensated for by adjusting the beam diameter of the input signal 34. Those skilled in the art will appreciate, however, that the dimensions, magnification power, pump power, input signal power, resonator dimensions, gain media material, and the like may be varied to provide desired output wavelength, output power, the beam quality, and the like. In one embodiment the gain media 42 comprises Yb:YAG; however, other laser materials are easily conceivable. As such, a laser amplifier system 10 is well-suited for compact, cost-effective, and high-beam-quality demanding laser micro-machining systems (fs, ps and ns), with output power from <50 W to >300 W.

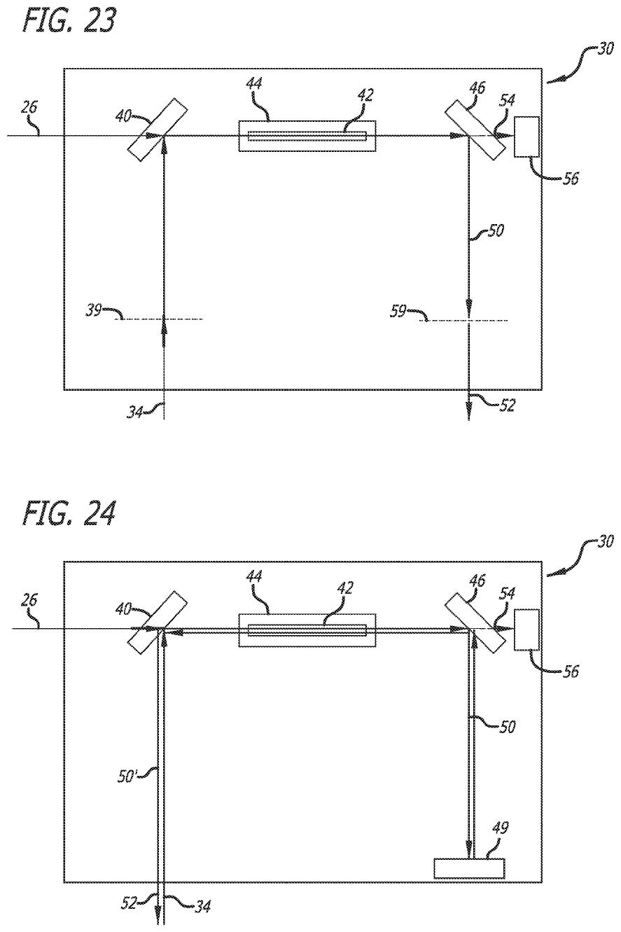

In addition, the laser amplifier system may be configured to offer a high small signal gain (>50 dB up to even as high as 80 dB) with a very high ASE and Parasitic Threshold as compared to prior art systems. Therefore, the present designs may be used as a high gain MOPA Amplifier (ps, ns, fs, etc.). For example, FIGS. 23 and 24 show alternate configurations of the RL amplifier 30. As shown in FIG. 23, the RL amplifier 30 may include at least on pump input mirror 40 and at least one pump output mirror 46. Like the previous embodiments, the pump source 12 provides at least one pump signal 14 to the RL amplifier 30. Although not shown, it should be understood that, like the previous embodiments, at least one telescope 16 may be configured to direct at least one pump signal 14 from the pump source 12 to the RL amplifier 30 by forming at least one amplifier pump signal 26 (see FIGS. 1 and 2). In addition, at least one input signal 34 is injected in the RL amplifier 30 via at least one coupling plane or device 39. The amplifier pump signal 26 and input signal 34 are directed to the gain media 42 secured with an optical mount 44. The gain media 42 outputs at least one amplifier signal 50 which may be directed to at least one output plane or device configured to output at least one amplified output signal from the RL amplifier 30. Like the previous embodiment, the expended amplifier pump signal is transmitted from the RL amplifier 30 via the pump output mirror 46 to at least one beam dump.

FIG. 23 shows an embodiment of a single pass amplification system for the amplification of an input signal 34. As such, the mirrors 40, 46 need not be tiled. In addition, the single pass configuration may permit for higher pump signal 14 power and/or signal 34 power. In the alternative, FIG. 24 shows another embodiment of the RL amplifier configured for double pass amplification. As shown, amplifier pump signal 26 and input signal 34 are directed to the gain media 42. In response, the gain media 42 outputs at least one amplifier signal 50 which is reflected by the amplifier mirror 49 back to the gain media 42. The gain media 42 again amplifies the amplifier signal 50 to form at least one re-amplified signal 50′. The re-amplified signal 50′ may be outputted from the RL amplifier 50 to form at least one amplifier output signal 52. Again, the mirrors 40, 46, 49 need not be tilted. Optionally, at least one of the mirrors 40, 46, 49 may be tilted. Further, the various embodiments shown in the present application may permit the amplifier output signal 52 to be injected into another amplifier. In another embodiment, the amplifier output signal 52 may be injected into one or more fiber optics devices or arrays, micro-lens arrays, lens systems, microscopes, and the like.

The embodiments disclosed herein are illustrative of the principles of the invention. Other modifications may be employed which are within the scope of the invention. Accordingly, the devices disclosed in the present application are not limited to that precisely as shown in described herein.

1. A laser amplifier system comprising:
at least one fiber-coupled laser diode array configured to output at least one pump signal having a wavelength from 850 nm to 1250 nm;
at least one telecentric telescope in optical communication with the at least one fiber-coupled laser diode array configured to receive the at least one pump signal and output at least one amplifier pump signal;
at least one signal source configured to output at least one input signal;
at least one resonator-like amplifier in communication with the at least one telecentric telescope and the at least one signal source, the resonator-like amplifier defined by at least one signal mirror, at least one pump injection mirror, at least one pump output mirror, and at least one mirror, wherein the at least one resonator-like amplifier has an optical path length from 50 mm to 700 mm defined by the at least one signal mirror, at least one pump input mirror, and least one pump output mirror, and at least one mirror; and
at least one optical crystal position within the at least one resonator-like amplifier and configured to receive at least a portion of the at least one pump signal and the at least one input signal and output at least one amplifier output signal from the at least one resonator-like amplifier.

2. The laser amplifier system of claim 1 wherein the fiber-coupled laser diode array comprises two or more fiber optic bodies, each fiber optic body configured to output at least one pump beamlet wherein the multiple beamlets forming the at least one pump signal.

3. The laser amplifier system of claim 1 wherein the at least one pump signal has a wavelength from 960 nm to 990 nm.

4. The laser amplifier system of claim 1 wherein the at least one pump signal has a wavelength from 970 nm to 980 nm.

5. The laser amplifier system of claim 1 wherein the at least one telecentric telescope has a target spot size ranging from 200 μm to about 800 μm.

6. The laser amplifier system of claim 1 wherein the at least one telecentric telescope has a target spot size ranging from 380 μm to about 475 μm.

7. The laser amplifier system of claim 1 wherein the at least one telecentric telescope has a magnification of 4×.

8. The laser amplifier system of claim 1 wherein the at least one telecentric telescope has a magnification of at least 2×.

9. The laser amplifier system of claim 1 wherein at least one of the at least one signal mirror, at least one pump injection mirror, at least one pump output mirror, and at least one mirror includes at least one dichroic coating configured to transmit that the at least one pump signal therethrough and reflect the at least one input signal.

10. The laser amplifier system of claim 1 wherein the optical path length ranges from 80 mm to 120 mm.

11. The laser amplifier system of claim 1 wherein the optical path length ranges from 100 mm to 110 mm.

12. The laser amplifier system of claim 1 wherein that least one input signal repeatedly traverses through the resonator-like amplifier such that the at least one input signal is repeatedly incident on a different spot on a facet of the at least one optical crystal.

13. The laser amplifier system of claim 1 wherein at least one signal mirror, at least one pump injection mirror, at least one pump output mirror, and at least one mirror is tilted relative to an optical axis of the resonator-like amplifier, wherein at least one amplified signal traversing within the resonator-like amplifier such that the at least one input signal traverses along a different optical path through the resonator-like cavity.

14. The laser amplifier system of claim 13 wherein at least one signal mirror, at least one pump injection mirror, at least one pump output mirror, and at least one mirror comprises a wedged body, wherein the at least one amplified signal traversing within the resonator-like amplifier such that the at least one input signal traverses along a different optical path through the resonator-like cavity.

15. The laser amplifier system of claim 1 wherein the at least one amplifier pump signal is comprised of multiple pump beamlets, each beamlet imaging at least one fiber-coupled laser diode forming the at least one fiber-coupled laser diode array wherein each beamlets forms an individual pump spot on at least one facet of the at least one optical crystal.

16. The laser amplifier system of claim 1 wherein the a least one optical crystal is manufactured from Yb:YAG.

17. The laser amplifier system of claim 1 wherein the a least one optical crystal is manufactured from at least one material selected from the group consisting of Yb:Lu2O3, Yb:Sc2O3, Yb:GGG, Yb:KYW, Yb:CALGO, Yb:CaF2, and Yb:CNGG.

18. The laser amplifier system of claim 1 wherein the at least one optical crystal has a uniform doping concentration.

19. The laser amplifier system of claim 1 wherein the at least one optical crystal has a non-uniform doping concentration.

20. The laser amplifier system of claim 1 wherein the at least one signal source comprises a mode-locked femtosecond laser source.

21. The laser amplifier system of claim 1 wherein the at least one signal source comprises at least one signal source selected from the group consisting of laser sources having one or more preamplifiers, broadband optical sources, picosecond optical sources, nanosecond optical sources, CW optical source, and resonator-like amplifiers.

22. The laser amplifier system of claim 1 further comprising at least one optional optical element positioned within the resonator-like amplifier, wherein the at least one optical element is selected from the group consisting of lens systems, micro lens arrays, filters, spatial filters, mechanical blockers in the form of one or more holes or lines, transmissive optical elements, gain media, optical crystals, polarizers, and wave plates.

23. A laser amplifier system comprising:
at least one fiber-coupled laser diode array configured to output at least one pump signal formed from multiple pump beamlets individually emitted from the at least one fiber-coupled laser diode array;
a telecentric telescope in optical communication with the at least one fiber-coupled laser diode array configured to receive the individual pump beamlets forming the at least one pump signal and output multiple individual amplifier pump signals;
at least one signal source configured to output at least one input signal;
at least one resonator-like amplifier in communication with the telecentric telescope and the at least one signal source, the resonator-like amplifier defined by at least one signal mirror, at least one pump injection mirror, at least one pump output mirror, and at least one mirror; and
an optical crystal position within the at least one resonator-like amplifier and configured to be pumped by the multiple individual amplifier pump signals and the at least one input signal and output at least one amplifier output signal from the at least one resonator-like amplifier.

24. A laser amplifier system comprising:
at least one fiber-coupled laser diode array configured to output at least one pump signal formed from multiple pump beamlets individually emitted from the at least one fiber-coupled laser diode array;
a telecentric telescope in optical communication with the at least one fiber-coupled laser diode array configured to receive the individual pump beamlets forming the at least one pump signal and output multiple individual amplifier pump signals;
at least one signal source configured to output at least one input signal;
at least one resonator-like amplifier in communication with the telecentric telescope and the at least one signal source; and
at least one optical crystal position within the at least one resonator-like amplifier and configured to be pumped by the individual pump beamlets and the at least one input signal and output at least one amplifier output signal from the at least one resonator-like amplifier.
